(19) United States
(12) Patent Application Publication
(10) Pub. No.: US 2008/0263348 A1
(43) Pub. Date: Oct. 23, 2008

(54) Dynamic asymmetric partitioning of program code memory in network connected devices

(75) Inventors: Etai Zaltsman, Ramat Hasharon (IL); Eran Genzel, Oranit (IL); Adam Lapid, Shoham (IL); Ran Senderovitz, Ramat Gan (IL)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 12/100,383

(22) Filed: Apr. 9, 2008

Related U.S. Application Data
(60) Provisional application No. 60/912,258, filed on Apr. 17, 2007.

(51) Int. Cl. G06F 12/02; G06F 9/00; H04N 7/173

(52) U.S. Cl. 713/2; 711/173; 725/111; 711/E12.002

(57) ABSTRACT

A novel asymmetric memory partitioning mechanism for providing resolving and reducing memory limitations when an increase in software image size is required. Two partitions are created in non-volatile memory, one smaller than the other. The smaller partition stores a degenerated version of the full-functionality software comprising only essential program code for booting the device and repeating the download and installation procedures until the full-functionality software image is successfully installed in non-volatile memory. The larger portion stores a full-functionality version of the software comprising both essential and non-essential program code. The mechanism also provides the capability of converting devices already deployed in the field. The legacy symmetrical partitioning of the memory in these devices is removed and replaced with asymmetrical partitioning, wherein the smaller partition stores the degenerated software image and the larger partition stores the full-functionality software image.

### REFERENCE TO PRIORITY APPLICATION

This application claims priority to U.S. Provisional Application Ser. No. 60/912,258, filed Apr. 17, 2007, entitled “Dynamic Asymmetric NVRAM Partitioning of Communication Devices in Remote-Upgradeable Environments”, incorporated herein by reference in its entirety.

### FIELD OF THE INVENTION

The present invention relates to the field of broadband communication devices and more particularly relates to a dynamic asymmetric partitioning mechanism for partitioning program code memory in network connected devices.

### BACKGROUND OF THE INVENTION

Currently there are more than 50 million high-speed Internet access customers in North America. Recently, the cable modem has become the broadband connection of choice for many Internet users, being preferred over the nearest rival broadband technology, Digital Subscriber Line (DSL), by a significant margin.

Cable modems are well known in the art. A cable modem is a type of modem that provides access to a data signal sent over the cable television (CATV) infrastructure. Cable modems are primarily used to deliver broadband Internet access, taking advantage of unused bandwidth on a cable television network. In 2005 there were over 22.5 million cable modem users in the United States alone.

A cable modem is a network appliance that enables high speed data connections to the internet via data services provided by the local cable company. Data from the home is sent upstream on a carrier that operates on the 5 MHz to 42 MHz band of the cable spectrum. Downstream data is carried on a 88 MHz to 860 MHz band. The cable modem system can have additional networking features such as Voice over IP (VoIP), wireless connectivity or network switch or hub functionality.

The term cable Internet access refers to the delivery of Internet service over the cable television infrastructure. The proliferation of cable modems, along with DSL technology, has enabled broadband Internet access in many countries. The bandwidth of cable modem service typically ranges from 3 Mbps up to 40 Mbps or more. The upstream bandwidth on residential cable modem service usually ranges from 384 kbps to 30 Mbps or more. In comparison, DSL tends to offer less speed and more variance between service packages and prices. Service quality is also far more dependent on the client's location in relation to the telephone company's nearest central office or Remote Terminal.

Users in a neighborhood share the available bandwidth provided by a single coaxial cable line. Therefore, connection speed varies depending on how many people are using the service at the same time. In most areas this has been eliminated due to redundancy and fiber networks.

With the advent of Voice over IP telephony, cable modems are also being used to provide telephone service. Many people who have cable modems have opted to eliminate their Plain Old Telephone Service (POTS). An alternative to cable modems is the Embedded Multimedia Terminal Adapter (EMTA). An EMTA allows multiple service operators (MSOs) to offer both High Speed Internet and VoIP through a single piece of customer premise equipment. A multiple system operator is an operator of multiple cable television systems.

Many cable companies have launched Voice over Internet Protocol (VoIP) phone service, or digital phone service, providing consumers a true alternative to standard telephone service. Digital phone service takes the analog audio signals and converts them to digital data that can be transmitted over the fiber optic network of the cable company. Cable digital phone service is currently available to the majority of U.S. homes with a large number of homes are now subscribing. The number of homes subscribing is currently growing by hundreds of thousands each quarter. One significant benefit of digital phone service is the substantial consumer savings, with one recent study saying residential cable telephone consumers could save an average of $135 or more each year.

To address the demand for increased bandwidth capabilities, MSOs use cable modems to deliver delivering information over networks from a central location (i.e. the head end) to residential and commercial end users. To facilitate such information delivery, the Data Over Cable Service Interface Specification (DOCSIS) standard is used to deliver digital data, such as internet information, to users over the existing coaxial lines of the Community Antenna Television system (CATV), which has been delivering cable television programming to users at least since the 1960's.

The Data Over Cable Service Interface Specification (DOCSIS) compliant cable modems have been fueling the transition of cable television operators from a traditional core business of entertainment programming to a position as full-service providers of video, voice, and data telecommunications services.

Cable systems transmit digital data signals over radio frequency (RF) carrier signals. To provide two-way communication, one carrier signal carries data in the downstream direction from the cable network to the customer and another carrier signal carries data in the upstream direction from the customer to the cable network. Cable modems are devices located at the subscriber premises that functions to convert digital information into a modulated RF signal in the upstream direction, and to convert the RF signals to digital information in the downstream direction. A cable modem termination system (CMTS) performs the opposite operation for multiple subscribers at the cable operator's head-end.

Typically, several hundreds of users share a 6 MHz downstream channel and one or more upstream channels. The downstream channel occupies the space of a single television transmission channel in the cable operator's channel lineup. It is compatible with digital set top MPEG transport stream modulation (64 or 256 QAM), and provides up to 40 Mbps. A media access control (MAC) layer coordinates shared access to the upstream bandwidth.

The latest DOCSIS specification, DOCSIS 3.0, include a number of enhancements. In order to provide faster data rates to customers, DOCSIS 3.0 introduces the concept of bonding several physical downstream channels into one virtual high speed pipe. Channel bonding is a load-sharing technique for logically combining multiple DOCSIS channels. DOCSIS 3.0 defines channel bonding for both the upstream and downstream directions. For downstream channel bonding, each downstream DOCSIS channel carries a payload of approximately 38 Mbps (50 Mbps with EuroDOCSIS). Load sharing traffic across multiple channels allows a maximum throughput of up to n×38 Mbps (or n×50 Mbps), with n representing the number of channels being bonded. A separate 6 MHz or 8 MHz frequency is used for each of the bonded channels. Upstream channel bonding is possible for a minimum of four channels, 10 to 30 Mbps each, for a total of 40 to 120 Mbps of shared throughput.

Cable modems and DOCSIS standard have made delivery of digital services over hybrid fiber coaxial (HFC) cable television systems possible. Digital data delivery of Internet data, video on demand movies, telephony, telephony over the Internet, interactive games, upstream delivery of security camera digital photos to security services and a host of other applications is now possible. These services and applications are useful and valuable with some requiring more bandwidth than others. Video and movies, for example, even when compressed using MPEG standards, require large amounts of bandwidth. The DOCSIS 3.0 specification also enables enhanced video applications that are much improved over earlier versions of the specification. The new video applications enable simultaneous multiple video channel reception.

A high level block diagram illustrating a prior art network device in communication with a software image source is shown in FIG. 1. The example network, generally referenced 190, comprises a network cloud 194 such as the Internet, broadband network, narrowband network, etc., software image source 192 and a network device 196 comprising non-volatile memory (e.g., NVRAM) 198. The network device may comprise, for example, a set top box or cable modem. When the non-volatile memory is to be updated with a new version of software, the software image is downloaded from the software image source 192 via the network 194 and installed in the non-volatile memory.

Currently, the DOCSIS standard requires that when the software operating system loaded on a cable modem is remotely updated with updated software code over the network, the cable modem be able to recover from download errors (e.g., incomplete download and update procedure) without the need for MSO personnel to manually update and restart the modem. In such a case, an MSO typically changes the filename of the software load in the configuration file that is downloaded from the head end to the cable modem when the modem ranges and registers. The cable modems then individually request new software corresponding to the updated filename from the head end. Note that other applications may use a broadcast download mechanism.

It will be appreciated that this process is used in the DOCSIS systems, but other applications may use a broadcast download routine. In addition, the Simple Network Management Protocol (SNMP) may be used for downloading updated software code to a cable modem in a DOCSIS system. SNMP allows the MSO to set various parameters on a cable modem remotely. Thus, an MSO sets the new filename of a new software load on a cable modem and instructs the cable modem to download it. This obviates the need for MSO personnel to physically visit a MSO subscriber's premises to upgrade, update or otherwise modify the operating system or other application software of a particular cable modem. Further, the cable modem may implement PacketCable software for facilitating voice telephony over the cable modem system.

Both the DOCSIS and PacketCable standards require that a cable modem be able to recover from an unsuccessful download and update procedure, which may be caused by any number of reasons, such as a loss of power during downloading and updating of code. If the code is only partially downloaded and updated in the event of a power loss, then the partial code remaining could make the modem inoperable.

A diagram illustrating the structure and allocation of a prior art non-volatile memory is shown in FIG. 2. The memory, generally referenced 200, comprises a boot portion 202, database portion 204, a first partition 214 of size n kB and second partition 216 of size n kB. The first partition 214 comprises a first software image 206 of size m′ kB and unused portion 208. The second partition 216 comprises second software image 210 of size m″ kB and unused portion 212. Both the first and second partitions are the same size n.

To overcome the potential inability to reboot a cable modem after a loss of code that may occur when the power loss occurs, cable modems are designed to store two copies of the code, rather than one, such as in first and second partitions 214, 216. Each copy includes both the operating system code as well as the application code. Thus, if a particular portion of code is interrupted during download, the modem is not rendered inoperable because the second copy of the code from before the download process was begun can be used to reboot the cable modem after power has been restored.

Upon boot-up of the device, the code is loaded from a flash memory device into random access memory (RAM). If the first copy of the operating system has been corrupted, then the system looks to the second copy (i.e. the backup copy). This ‘dual banking’ scheme provides adequate protection against an incomplete or corrupt download of updated software. A disadvantage, however, is that twice the amount of flash memory space is required to store two separate and complete sets of code in a compressed format wherein each set comprises both operating and applications code.

In broadband environments such as cable, there is a growing need for cost reduction to new communications equipment such as cable modems, voice enabled cable modems (embedded multimedia terminal adapters or EMTAs), residential gateway cable devices, embedded cable modems (ECM), set top boxes. The need to reduce the cost of such systems is occurring in parallel with the need for increasing the features and functionality of previously deployed devices (i.e. legacy deices).

The addition of new features and functionality to existing communications products results in an increase in the size of the software image in these devices, which, in turn drives the need for larger and more costly memory devices.

Since the cost of flash memory used in cable modem is significant, the overall cost is increased for a cable modem designed to use a dual banking scheme. The increase in the size of the software image is problematic when the size of the memory needed grows to a level above the available memory in currently deployed devices. The problem with previously devices is that the size of their installed memory cannot be changed, resulting in an inability of upgrading field deployed devices.

It is common for broadband communication devices to require the allocation of memory storage space for two software images. Two software images are required to enable the safe remote reprogramming of the device. Two software images essentially protect the device from being incapacitated due to (1) programming failures or errors; (2) one or more corrupt software images; (3) power failures; or (4) connectivity failures during the programming process. In the event an upgrade is interrupted or fails, the device (which contains two independent NVRAM software images) falls back to the second software image, which remains intact.

Thus, current devices require a symmetrical structure having two identical sized partitions in the NVRAM to hold both software images. This structure, however, creates a limitation on the size of the software image which can be programmed into the memory of previously deployed devices. It also requires the use of larger and more expensive NVRAM components in new devices.

Thus, there is a need for a mechanism that is capable of partitioning program code memory in a network connected communications device such that memory limitations are significantly reduced when an increase in the size of the software image is needed. The mechanism should eliminate the requirement of storing two identical copies of the software image. The downloading of code from a centralized service (e.g., cable head end or CMTS) should also preserve any current protection of the modem against an incomplete download of the upgrade software which could result in the inability to reboot the modem. Furthermore, there is a need for a method and system for downloading and updating program code in NVRAM in previously deployed devices that permits an increase in the size of the software image not requiring any physical memory size increases which are costly or impractical.

### SUMMARY OF THE INVENTION

The present invention is a novel asymmetric memory partitioning mechanism for providing resolving and reducing memory limitations when an increase in software image size is required. The asymmetric memory partitioning mechanism of the present invention is applicable to deployed devices that normally maintain two complete full-functionality software images, simultaneously and independently of each other. The mechanism is especially applicable to previously deployed network connected communication devices that otherwise would be able to accept the increased size of current software image upgrades. An advantage of the fail safe mechanism is that it reduces both product returns and service calls from operators and vendors. One example of the application of the invention is use in a cable modem system adapted to implement the DOCSIS specification.

The mechanism is operative to create two partitions in non-volatile memory, one smaller than the other. The smaller partition is adapted to store a degenerated (i.e. significantly reduced) version of the full-functionality software comprising only essential program code. The larger portion is adapted to store a full-functionality version of the software comprising both essential and non-essential program code. This degenerated software image comprises only program code considered essential for booting the device and repeating the download and installation procedures until the full-functionality software image is successfully installed in non-volatile memory.

The mechanism also provides the capability of converting devices already deployed in the field. The legacy symmetrical partitioning of the memory in these devices is removed and replaced with asymmetrical partitioning, wherein the smaller partition stores the degenerated software image and the larger partition stores the full-functionality software image.

To aid in understanding the principles of the present invention, the description is provided in the context of a DOCSIS capable cable system (i.e. DOCSIS 3.0, EuroDOCSOS 3.0, etc.) comprising a cable modem adapted to receive an DOCSIS compatible RF signal feed from a cable head-end (i.e. CMTS) and to distribute video, Internet and telephony to a subscriber premises. It is appreciated, however, that the invention is not limited to use with any particular communication device or standard and may be used in optical, wired and wireless applications. Further, the invention is not limited to use with a specific technology but is applicable to any situation which can benefit from improved common mode rejection of a differential amplifier.

Several advantages of the asymmetric memory partitioning mechanism of the present invention include (1) the ability to reduce at least maintain the current cost of devices Bill or Material (BOM) while extending the functionality of the device by enabling the use of smaller non-volatile memory components; (2) the ability to perform upgrades of field deployed devices with software images and applications that support additional functionality, which otherwise could not have been used due to non-volatile memory size limitations of the deployed devices; (3) the ability to perform the upgrade in a seamless remote process that does not require technician intervention or product replacement.

Note that many aspects of the invention described herein may be constructed as software objects that are executed in embedded devices as firmware, software objects that are executed as part of a software application on either an embedded or non-embedded computer system running a real-time operating system such as WinCE, Symbian, OSE, Embedded LINUX, etc. or non-real time operating system such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the invention, a method of partitioning non-volatile memory in a network connected communications device, the method comprising the steps of storing a degenerated software image in a first partition of the non-volatile memory and storing a single copy of a full-functionality software image in a second partition of the non-volatile memory, the second partition asymmetrical to and larger in size than the first partition.

There is also provided in accordance with the invention, a method of partitioning non-volatile memory in a network connected communications device, the method comprising the steps of receiving an updated full-functionality software image, a single copy of which is to be installed in the non-volatile memory, wherein the non-volatile memory having a first partition for storing a degenerated software image therein and a second partition for storing a full-functionality software image, the second partition asymmetrical to and larger in size than the first partition and overwriting the current contents of the second partition with the updated version of the full-functionality software image.

There is further provided in accordance with the invention, a method of converting non-volatile memory in a previously deployed network connected communications device, the method comprising the steps of creating a first partition in the non-volatile memory, creating a second partition in the non-volatile memory, wherein the second partition is asymmetrical to and larger in size than the first partition, storing a degenerated software image in the first partition and storing a single copy of a full-functionality software image in the second partition of the non-volatile memory.

There is also provided in accordance with the invention, a non-volatile memory for use in a network connected communications device comprising a first partition for storing a degenerated software image and a second partition for storing a single copy of a full-functionality software image, wherein the second partition is asymmetrical to and larger in size than the first partition.

There is further provided in accordance with the invention, a cable modem comprising one or more memory modules comprising a non-volatile memory, the non-volatile memory comprising, a first partition for storing a degenerated software image, a second partition for storing a single copy of a full-functionality software image, wherein the second partition is asymmetrical to and larger in size than the first partition, one or more interface ports, a downstream system connected to a CATV radio frequency (RF) signal input and operative to output a plurality of channel data therefrom, an upstream system connected to the CATV radio frequency (RF) signal input and a processor coupled to the one or more memory modules, the one or more interface ports, the downstream system and the upstream system, the processor operative to implement a media access control (MAC) layer operative to generate a plurality of output channels.

### BRIEF DESCRIPTION OF THE DRAWINGS

The invention is herein described, by way of example only, with reference to the accompanying drawings, wherein:

FIG. 1 is a high level block diagram illustrating a prior art network device in communication with a software image source;

FIG. 2 is a diagram illustrating the structure and allocation of a prior art non-volatile memory;

FIG. 3 is a block diagram illustrating an example cable modem system incorporating the asymmetric memory partitioning mechanism of the present invention;

FIG. 4 is a block diagram illustrating an example cable modem incorporating the asymmetric memory partitioning mechanism of the present invention;

FIG. 5 is a diagram illustrating the capture bandwidth of the downstream band received from the CMTS;

FIG. 6 is a simplified block diagram illustrating the processor of the cable modem of FIG. 4 and its connection to non-volatile memory with asymmetric partitioning in accordance with the present invention;

FIG. 7 is a diagram illustrating the structure and allocation of non-volatile memory in accordance with the asymmetric memory partitioning mechanism of the present invention;

FIG. 8 is a flow diagram illustrating the non-volatile memory partitioning method of the present invention;

FIG. 9 is a flow diagram illustrating the update software image method of the present invention; and

FIG. 10 is a flow diagram illustrating the deployed device conversion method of the present invention.

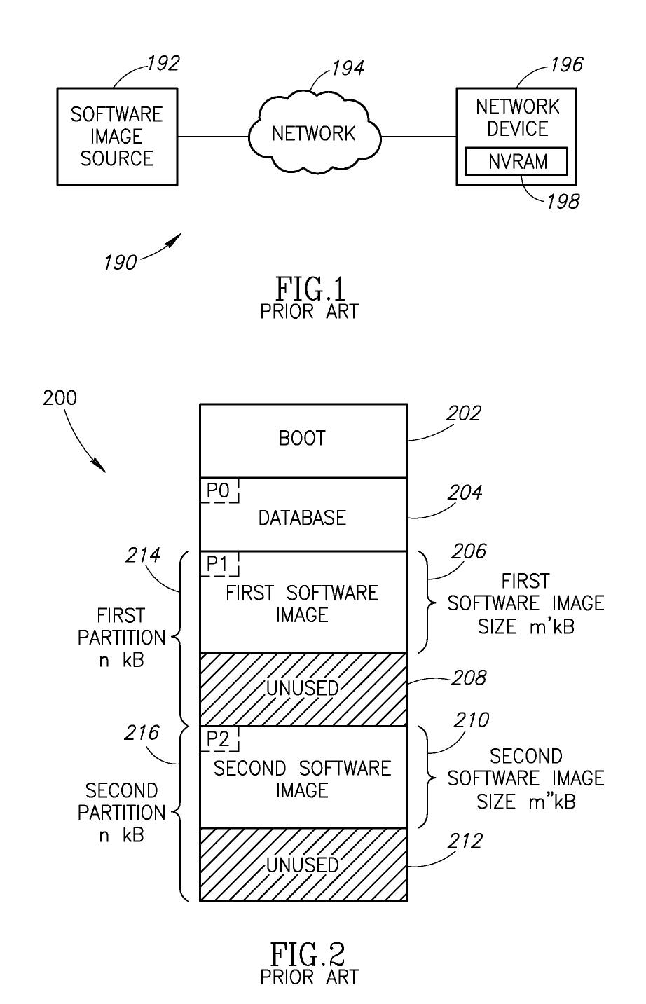

### DETAILED DESCRIPTION OF THE INVENTION

### Notation Used Throughout

The following notation is used throughout this document.

| Term | Definition |
|---|---|
| AC | Alternating Current |
| ADC | Analog to Digital Converter |
| ASIC | Application Specific Integrated Circuit |
| ATM | Asynchronous Transfer Mode |
| AVI | Audio Video Interface |
| BMP | Windows Bitmap |
| BOM | Bill of Material |
| BWA | Broadband Wireless Access |
| CATV | Community Antenna Television or Cable TV |
| CBW | Capture Bandwidth |
| CM | Cable Modem |
| CMTS | Cable Modem Termination System |
| CO | Central Office |
| CPU | Central Processing Unit |
| CRC | Cyclic Redundancy Code |
| DAC | Digital to Analog Converter |
| DC | Direct Current |
| DECT | Digital Enhanced Cordless Telecommunications |
| DHCP | Dynamic Host Control Protocol |
| DOCSIS | Data Over Cable Service Interface Specification |
| DS | Downstream |
| DSL | Digital Subscriber Line |
| DSP | Digital Signal Processor |
| DVR | Digital Video Recorder |
| ECM | Embedded Cable Modem |
| EDGE | Enhanced Data rates for GSM Evolution |
| EEPROM | Electrically Erasable Programmable Read Only Memory |
| EEROM | Electrically Erasable Read Only Memory |
| EMTA | Embedded Multimedia Terminal Adapter |
| EPROM | Erasable Programmable Read Only Memory |
| EVDO | Evolution-Data Optimized |
| FPGA | Field Programmable Gate Array |
| GPIO | General Purpose I/O |
| GSM | Global System for Mobile Communication |
| HDL | Hardware Description Language |
| HFC | Hybrid Fiber Coaxial |
| I/F | Interface |
| I/O | Input/Output |
| IC | Integrated Circuit |
| IP | Internet Protocol |
| JPG | Joint Photographic Experts Group |
| LAN | Local Area Network |
| LED | Light Emitting Diode |
| LTE | Long Term Evolution |
| MAC | Media Access Control |
| MP3 | MPEG-1 Audio Layer 3 |
| MPEG | Moving Picture Experts Group |
| MPG | Moving Picture Experts Group |
| MSO | Multiple System Cable Operator |
| NVRAM | Non-Volatile Random Access Memory |
| PC | Personal Computer |
| PDA | Personal Digital Assistant |
| PGA | Programmable Gain Amplifier |
| POTS | Plain Old Telephone Service |
| PSTN | Public Switched Telephone Network |
| QAM | Quadrature Amplitude Modulation |
| QoS | Quality of Service |
| RAM | Random Access Memory |
| RAT | Radio Access Technology |
| RF | Radio Frequency |
| ROM | Read Only Memory |
| SLIC | Subscriber Line Interface Card |
| SNMP | Simple Network Management Protocol |
| SONET | Synchronous Optical Network |
| TB | Tuning Band |
| UMB | Ultra Mobile Broadband |
| UMTS | Universal Mobile Telecommunications System |
| US | Upstream |
| USB | Universal Serial Bus |
| VoIP | Voice over IP |
| WAN | Wide Area Network |
| WCDMA | Wideband Code Division Multiple Access |
| WiFi | Wireless Fidelity |
| WiMAX | Worldwide Interoperability for Microwave Access |
| WLAN | Wireless Local Area Network |
| WMA | Windows Media Audio |
| WMV | Windows Media Video |

### DETAILED DESCRIPTION OF THE INVENTION

The present invention is a novel asymmetric memory partitioning mechanism for providing resolving and reducing memory limitations when an increase in software image size is required. The asymmetric memory partitioning mechanism of the present invention is applicable to deployed device that normally maintain two complete full-functionality software images, simultaneously and independently of each other. The mechanism is especially applicable to previously deployed network connected communication devices that otherwise would be able to accept the increased size of current software image upgrades. An advantage of the fail safe mechanism is that it reduces both product returns and service calls from operators and vendors. One example of the application of the invention is use in a cable modem system adapted to implement the DOCSIS specification.

To aid in understanding the principles of the present invention, the description is provided in the context of a DOCSIS capable cable system comprising a cable modem adapted to receive a DOCSIS compatible RF signal feed from a cable head-end (i.e. CMTS) and to distribute video, Internet and telephony to a subscriber premises. It is appreciated, however, that the invention is not limited to use with any particular communication device or standard and may be used in optical, wired and wireless applications. Further, the invention is not limited to use with a specific technology but is applicable to any situation which can benefit from improved common mode rejection of a differential amplifier.

Note that throughout this document, the term communications transceiver, communications device or network device is defined as any apparatus or mechanism adapted to transmit, receive or transmit and receive information through a medium. The communications device, communications transceiver or network device may be adapted to communicate over any suitable medium, including wireless or wired media. Examples of wireless media include RF, infrared, coaxial, optical, microwave, UWB, Bluetooth, WiMAX, GSM, EDGE, UMTS, WCDMA, 3GPP-LTE, CDMA-2000, EVDO, EVDV, UMB, WiFi, or any other broadband medium, radio access technology (RAT), etc. Examples of wired media include twisted pair, coaxial, optical fiber, any wired interface (e.g., USB, Firewire, Ethernet, etc.). The terms communications channel, link and cable are used interchangeably. The terms communications device, communications transceiver or network device are also intended to denote other devices including, but not limited to, a set top box, cable modem, EMTA, residential gateway cable device, embedded cable modem, a multimedia player, mobile communication device, cellular phone, node in a broadband wireless access (BWA) network, smartphone, PDA, wireless LAN (WLAN) and Bluetooth device.

The term cable modem is defined as a modem that provides access to a data signal sent over the cable television infrastructure. The term voice cable modem is defined as a cable modem that incorporates VoIP capabilities to provide telephone services to subscribers.

The term ‘essential code’ is defined as code required to enable the communication device to boot and repeatedly attempt to download and install the full-functionality software upgrade until it is successfully installed. The term ‘non-essential’ code refers to all other code including not only operating system software, but other code for proper operation of the cable modem, such as in a DOCSIS compliant manner.

The word ‘exemplary’ is used herein to mean ‘serving as an example, instance, or illustration.’ Any embodiment described herein as ‘exemplary’ is not necessarily to be construed as preferred or advantageous over other embodiments.

The term multimedia player or device is defined as any apparatus having a display screen and user input means that is capable of playing audio (e.g., MP3, WMA, etc.), video (AVI, MPG, WMV, etc.) and/or pictures (JPG, BMP, etc.) and/or other content widely identified as multimedia. The user input means is typically formed of one or more manually operated switches, buttons, wheels or other user input means. Examples of multimedia devices include pocket sized personal digital assistants (PDAs), personal media player/recorders, cellular telephones, handheld devices, and the like.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing a combination of hardware and software elements. In one embodiment, a portion of the mechanism of the invention is implemented in software, which includes but is not limited to firmware, resident software, object code, assembly code, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (USB flash drives, etc.), ROM, EPROM, or other semiconductor memory devices.

### Cable System Incorporating Asymmetric Memory Partitioning Mechanism

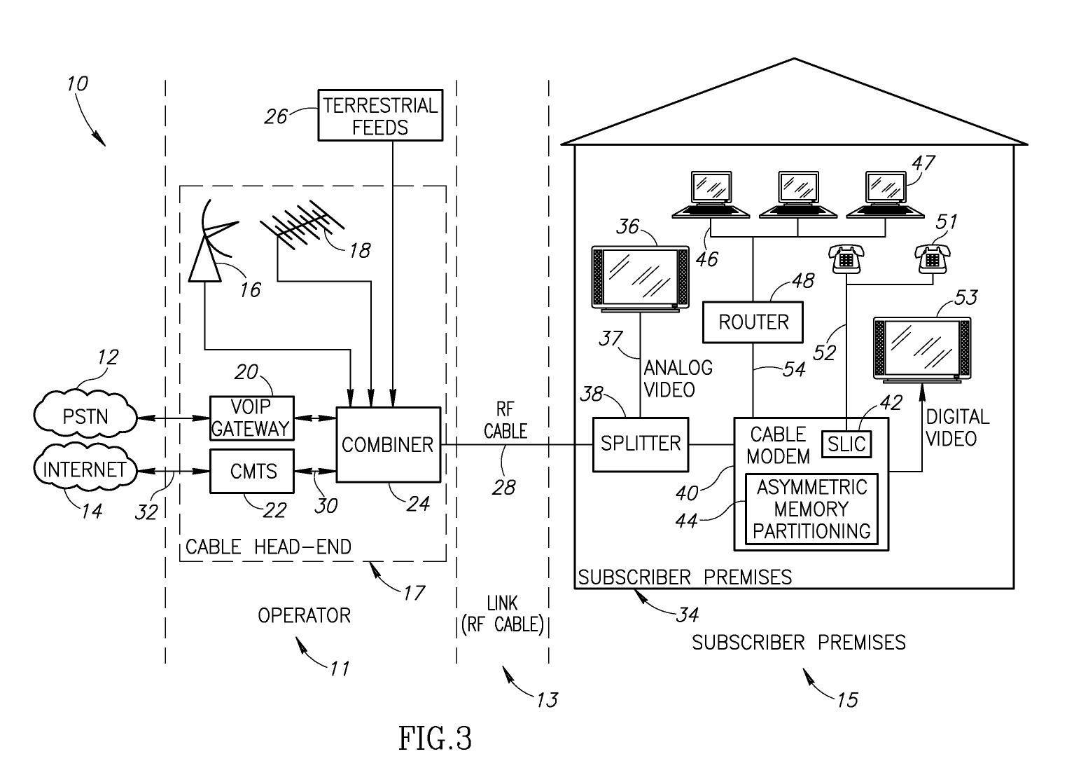

A block diagram illustrating an example cable modem system incorporating the asymmetric memory partitioning mechanism of the present invention is shown in FIG. 3. The system, generally referenced 10, comprises an operator portion 11 connected to the public switched telephone network (PSTN) 12 and the Internet 14 or other wide area network (WAN), a link portion 13 comprising the RF cable 28 and a subscriber portion 15 comprising the subscriber premises 34.

The operator portion 11 comprises the cable head-end 17 which is adapted to receive a number of content feeds such as satellite 16, local antenna 18 and terrestrial feeds 26, all of which are input to the combiner 24. The cable head-end also comprises the voice over IP (VoIP) gateway 20 and Cable Modem Termination System (CMTS) 22. The combiner merges the TV programming feeds with the RF data from the CMTS.

The Cable Modem Termination System (CMTS) is a computerized device that enables cable modems to send and receive packets over the Internet. The IP packets are typically sent over Layer 2 and may comprise, for example, Ethernet or SONET frames or ATM cell. It inserts IP packets from the Internet into MPEG frames and transmits them to the cable modems in subscriber premises via an RF signal. It does the reverse process coming from the cable modems. A DOCSIS-compliant CMTS enables customer PCs to dynamically obtain IP addresses by acting as a proxy and forwarding DHCP requests to DHCP servers. A CMTS may provide filtering to protect against theft of service and denial of service attacks or against hackers trying to break into the cable operator's system. It may also provide traffic shaping to guarantee a specified quality of service (QoS) to selected customers. A CMTS may also provide bridging or routing capabilities.

The subscriber premises 34 comprises a splitter 38, cable appliances 36 such as televisions, DVRs, etc., cable modem 40, router 48, PCs or other networked computing devices 47 and telephone devices 51. Cable service is provided by the local cable provider wherein the cable signal originates at the cable head end facility 17 and is transmitted over RF cable 28 to the subscriber premises 34 where it enters splitter 38. One output of the splitter goes to the televisions, set top boxes, and other cable appliances via internal cable wiring 37.

The other output of the splitter comprises the data portion of the signal which is input to the cable modem 40. The cable modem is adapted to provide both Ethernet and USB ports. Typically, a router 48 is connected to the Ethernet port via Ethernet cable 54. One or more network capable computing devices 47, e.g., laptops, PDAs, desktops, etc. are connected to the router 48 via internal Ethernet network wiring 46. In addition, the router may comprise or be connected to a wireless access point that provides a wireless network (e.g., 802.11b/g/a) throughout the subscriber premises.

The cable modem also comprises a subscriber line interface card (SLIC) 42 which provides the call signaling and functions of a conventional local loop to the plurality of installed telephone devices 51 via internal 2-wire telephone wiring 52. In particular, it generates call progress tones including dial tone, ring tone, busy signals, etc. that are normally provided by the local loop from the CO. Since the telephone deices 51 are not connected to the CO, the SLIC in the cable modem must provide these signals in order that the telephone devices operate correctly.

The cable modem also comprises an asymmetric memory partitioning block 44 incorporating the asymmetric memory partitioning mechanism of the present invention, described in more detail infra. A digital video output signal generated by the cable modem is displayed to the user (i.e. cable subscribers) via television set 53 (i.e. video display device or other cable appliance). Tuner circuits in the cable modem enable the reception of multiple video channels simultaneously.

### Cable Modem Incorporating Asymmetric Memory Partitioning Mechanism

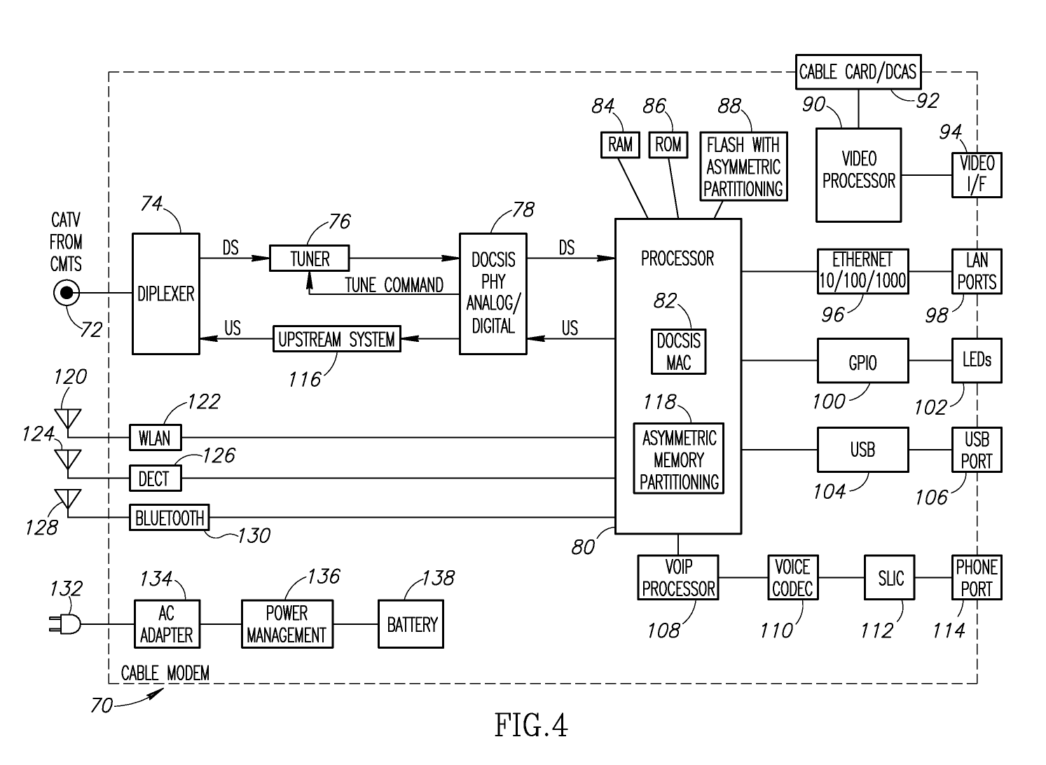

A block diagram illustrating an example cable modem incorporating the asymmetric memory partitioning mechanism of the present invention is shown in FIG. 4. The cable modem, generally referenced 70, comprises an upstream system and a downstream system. The downstream system comprises a duplexer 74, tuner 76 and DOCSIS PHY circuit 78. The upstream system comprises the DOCSIS PHY circuit 78, upstream system circuit 116 and diplexer 74.

The cable modem also comprises DOCSIS compatible processor 80, DOCSIS MAC 82, VoIP processor 108, voice codec 110, subscriber line interface card (SLIC) 112, phone port 114, wireless local area network (WLAN) 122 and associated antenna 120, DECT 126 and associated antenna 124, Bluetooth 130 and associated antenna 128, Ethernet interface 96, Ethernet LAN port 98, general purpose input/output (I/O) (GPIO) interface 100, LEDs 102, universal serial bus (USB) interface 104, USB port 106, cable card/Downloadable Conditional Access Systems (DCAS) 92, video interface (I/F) 94, video processor 90, AC adapter 134 coupled to mains utility power via plug 132, power management circuit 136, battery 138, RAM, 84, ROM 86 and flash memory 88.

Note that in the example embodiment presented herein, the cable modem and DOCSIS enabled processor are adapted to implement the DOCSIS 3.0 standard which provides for multiple channel video reception. It is appreciated, however, that the invention is not limited to use in a DOCSIS compatible cable modem but is applicable to numerous other differential amplifier circuit applications as well.

In operation, the cable modem processor is the core chip set which in the example presented herein comprises a central single integrated circuit (IC) with peripheral functions added. The voice over IP (VoIP) processor 108 implements a mechanism to provide phone service outside the standard telco channel. Chipset DSPs and codecs 110 add the functionality of POTS service for low rate voice data.

The cable modem also comprises a subscriber line interface card (SLIC) 112 which functions to provide the signals and functions of a conventional local loop to a plurality of telephone devices connected via the phone port 114 using internal 2-wire telephone wiring. In particular, it generates call progress tones including dial tone, ring tone, busy signals, etc. that are normally provided by the local loop from the CO. Since the telephone deices are not connected to the CO, the SLIC in the cable modem must provide these signals in order that the telephone devices operate correctly.

In a traditional analog telephone system, each telephone or other communication device (i.e. subscriber unit) is typically interconnected by a pair of wires (commonly referred to as tip and ring or together as subscriber lines, subscriber loop or phone lines) through equipment to a switch at a local telephone company office (central office or CO). At the CO, the tip and ring lines are interconnected to a SLIC which provides required functionality to the subscriber unit. The switches at the central offices are interconnected to provide a network of switches thereby providing communications between a local subscriber and a remote subscriber.

The SLIC is an essential part of the network interface provided to individual analog subscriber units. The functions provided by the SLIC include providing talk battery (between 5 VDC for on-hook and 48 VDC for off-hook), ring voltage (between 70-90 VAC at a frequency of 17-20 Hz), ring trip, off-hook detection, and call progress signals such as ringback, busy, and dial tone.

A SLIC passes call progress tones such as dial tone, busy tone, and ringback tone to the subscriber unit. For the convenience of the subscriber who is initiating the call, these tones normally provided by the central office give an indication of call status. When the calling subscriber lifts the handset or when the subscriber unit otherwise generates an off hook condition, the central office generates a dial tone and supplies it to the calling subscriber unit to indicate the availability of phone service. After the calling subscriber has dialed a phone number of the remote (i.e. answering) subscriber unit, the SLIC passes a ring back sound directed to the calling subscriber to indicate that the network is taking action to signal the remote subscriber, i.e. that the remote subscriber is being rung. Alternatively, if the network determines that the remote subscriber unit is engaged in another call (or is already off-hook), the network generates a busy tone directed to the calling subscriber unit.

The SLIC also acts to identify the status to, or interpret signals generated by, the analog subscriber unit. For example, the SLIC provides −48 volts on the ring line, and 0 volts on the tip line, to the subscriber unit. The analog subscriber unit provides an open circuit when in the on-hook state. In a loop start circuit, the analog subscriber unit goes off-hook by closing, or looping the tip and ring to form a complete electrical circuit. This off-hook condition is detected by the SLIC (whereupon a dial tone is provided to the subscriber). Most residential circuits are configured as loop start circuits.

Connectivity is provided by a standard 10/100/1000 Mbps Ethernet interface 96 and Ethernet LAN ports 98, USB interface 104 and USB ports 106 or with additional chip sets, such as wireless 802.11a/b/g via WLAN interface 122 coupled to antenna 120. In addition, a GPIO interface 100 provides an interface for LEDs 102, etc. The network connectivity functions may also include a router or Ethernet switch core. Note that the DOCSIS MAC 82 and PHY 78 may be integrated into the cable modem processor 80 or may be implemented separately as shown in FIG. 4 wherein the DOCSIS PHY circuit 78 is shown implemented separately from the processor 80. In addition, the processor or other entity is operative to implement the asymmetric partitioning mechanism of the present invention.

In the example embodiment presented herein, the tuner 76 is coupled to the CATV signal from the CMTS via port 72 and is operative to convert the RF signal received over the RF cable to an IF frequency in accordance with the tune command signal received from the processor.

The cable modem 70 comprises a processor 80 which may comprise a digital signal processor (DSP), central processing unit (CPU), microcontroller, microprocessor, microcomputer, ASIC, FPGA core or any other suitable processing means. The cable modem also comprises static read only memory (ROM) 86, dynamic main memory 84 and flash memory 88 all in communication with the processor via a bus (not shown). The flash (i.e. non-volatile memory) is partitioned asymmetrically in accordance with the mechanism of the present invention, as described in more detail infra.

The magnetic or semiconductor based storage device 84 (i.e. RAM) is used for storing application programs and data. The cable modem comprises computer readable storage medium that may include any suitable memory means, including but not limited to, magnetic storage, optical storage, semiconductor volatile or non-volatile memory, biological memory devices, or any other memory storage device.

In one example embodiment, any software required to implement the asymmetric partitioning mechanism of the present invention is adapted to reside on a computer readable medium, such as a magnetic disk within a disk drive unit. Alternatively, the computer readable medium may comprise a floppy disk, removable hard disk, flash memory, EEROM based memory, bubble memory storage, ROM storage, distribution media, intermediate storage media, execution memory of a computer, and any other medium or device capable of storing for later reading by a computer a computer program implementing the system and methods of this invention. The software adapted to implement the asymmetric partitioning mechanism of the present invention may also reside, in whole or in part, in the static or dynamic main memories or in firmware within the processor of the computer system (i.e. within microcontroller, microprocessor or microcomputer internal memory).

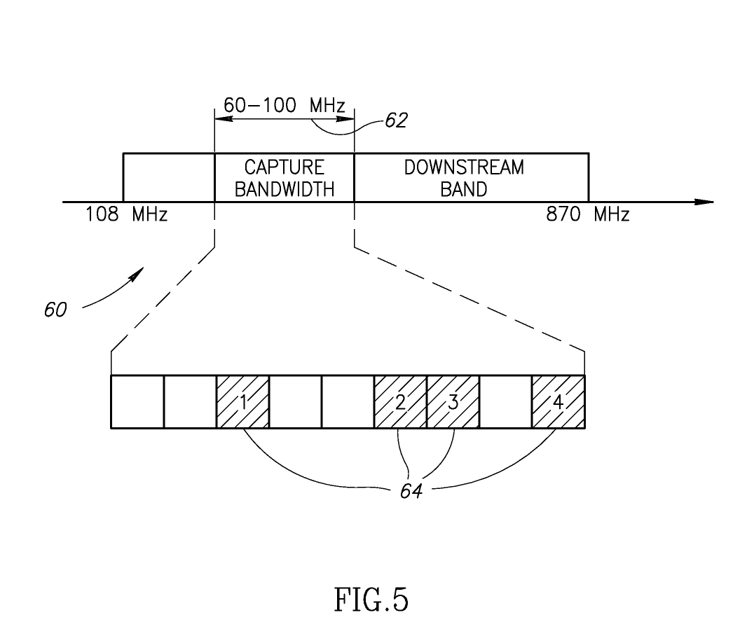

A diagram illustrating the capture bandwidth (CBW) of the downstream band received from the CMTS is shown in FIG. 5. In accordance with the DOCSIS 3.0 specification, used here for illustration purposes only, the downstream (DS) frequency band range, generally referenced 60, extends from 108 MHz to 870 MHz. The capture bandwidth 62 (defined as the sum of the tuning bands in the tuning band (TB) list) is between 60 and 100 MHz in width and may lie anywhere in the DS band. The TB is defines a single continuous frequency interval, in MHz, located anywhere in the downstream band (108 MHz to 870 MHz). The tuning band list (TB List) is defined as a list of one or more Tuning Bands supported by the cable modem that defines the cable modem tuning capabilities.

Within the capture bandwidth, are four DS channels 64 that can be located anywhere in the capture bandwidth. An example arrangement of the four DS channels is shown in FIG. 5 where the four DS channels are indicated by the crosshatched channels 64.

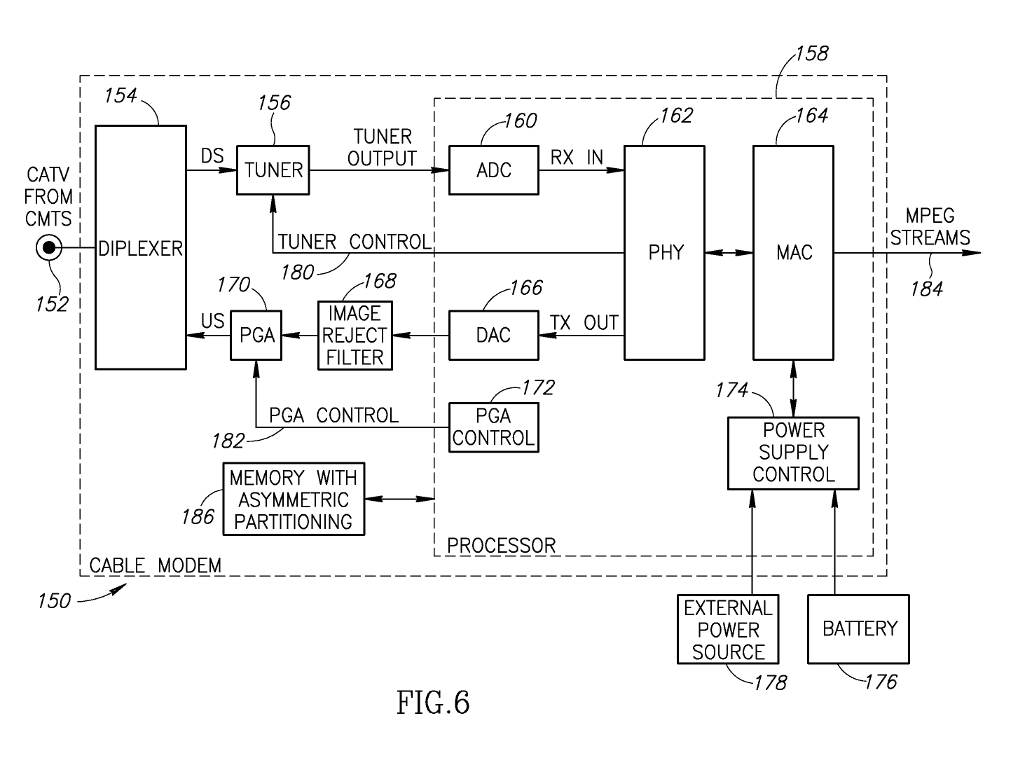

A simplified block diagram illustrating the processor of the cable modem of FIG. 4 and its connection to non-volatile memory with asymmetric partitioning in accordance with the present invention is shown in FIG. 6. The example cable modem, generally referenced 150, comprises diplexer 154 coupled to a CATV input 152, tuner circuit 156, processor 158, image reject filter 168 and PGA 170. The processor 158 is coupled to memory block 186 with asymmetric partitioning and comprises an analog to digital converter (ADC) 160, PHY circuit 162, digital to analog converter (DAC) 166, PGA control circuit 172, power supply control 74 and MAC 164. Power is supplied by an external power source 178 e.g., utility power, etc. or a battery 176.

In operation, in the downstream (i.e. receive) direction, the receive signal from the diplexer is input to the tuner circuit 156. The tuner output signals are input to the one or more ADCs to provide one or more RX I and Q input signals to the PHY circuit. The PHY circuit provides a tuner control signal 180 that controls the tuning of the tuner sub-circuits within the tuner. After MAC processing, one or more MPEG video streams 184 are output of the cable modem.

In the upstream (US) (i.e. transmit) direction, a digital TX output signal provided by the PHY circuit is converted to analog by the DAC. The analog signal is then filtered via the image reject filter before being amplified by the PGA whose gain is controlled by a PGA control signal 182 generated by the PGA control circuit 172.

### Asymmetric Memory Partitioning Mechanism

Rather than partition the non-volatile memory in a symmetrical manner to accommodate the dual banking scheme of the prior art, the mechanism of the present invention uses an asymmetric structure for the non-volatile memory. In accordance with the present invention, the non-volatile memory is partitioned such that one partition is larger than the other, resulting in an asymmetrical memory structure. Further, rather than store two identical copies (a master and backup copy, or current and previous copy) of the full-functionality software image (i.e. the program code that operates the communications device), only a single full-functionality copy is stored. In the place of the second copy, the smaller partition comprises a degenerated version of the full-functionality software image version.

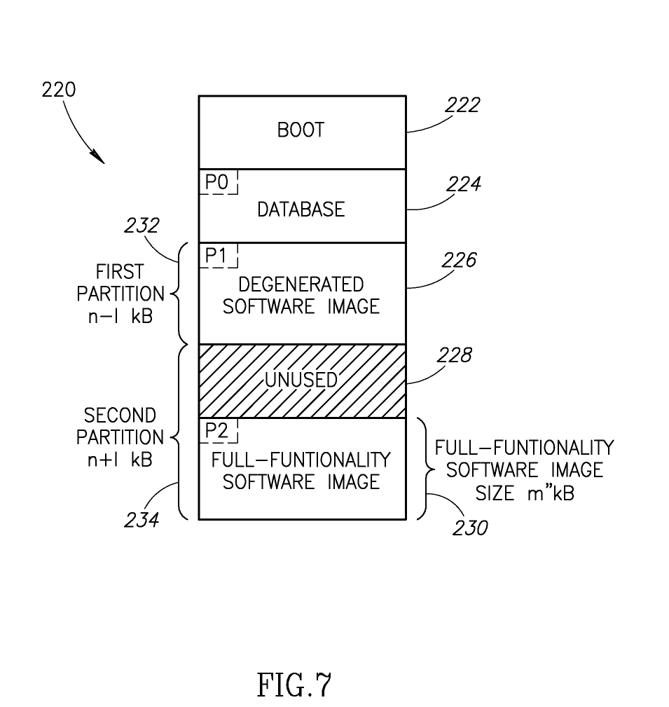

A diagram illustrating the structure and allocation of non-volatile memory in accordance with the asymmetric memory partitioning mechanism of the present invention is shown in FIG. 7. The memory, generally referenced 220, comprises a boot portion 222, database portion 224, a first partition 232 of size n−l kB and second partition 234 of size n+l kB, wherein n is a positive integer representing the size of the prior art dual bank partitions, and l is a positive integer representing half the difference in size between the first and second partitions. The first partition 232 comprises the degenerated software image 226. The second partition 234 comprises the full-functionality software image 230 of size m″ kB and unused portion 228.

The degenerated version of the software image 226 comprises only program code essential to maintain the basic capabilities of the communications device, specifically the capability to repeat the upgrade process until the installation of a new updated version of the full-functionality software image is successfully installed. The full-functionality software image 230 comprises the complete program code including all essential and non-essential program code for operating the communications device. The degenerated software image contains code to enable the device in case of a power or connectivity failure during remote device upgrade procedure to maintain basic capabilities of the device and specifically the ability to continue attempts at upgrading until successful installation of the updated version of the full-functionality software image.

The division between the two partitions can be performed in either of two ways: (1) dynamic partitioning, or (2) static partitioning, which may be set as a subset of dynamic partitioning.

Dynamic partitioning enables the partitioning in previously deployed products to be changed. In variably, as new versions of the software are developed, the size of the updated versions of the software image increase. Thus, as the size of the software image changes, the partition in deployed products also changes thereby keeping the small partition storing the degenerated software image the same size while permitting more space for present and future full-functionality software images.

Due to the dynamic nature of the division of the memory and the location of the software images in the partitions, the degenerated software image can also be remotely upgraded if needed.

Static partitioning is a simpler implementation which provides the gains associated with asymmetrical software images albeit with less complex implementation. Static partitioning, however, is less optimal and results in lower utilization of the memory.

In addition, the present invention provides a mechanism to convert previously deployed devices from a symmetrical non-volatile memory structure to an asymmetrical non-volatile memory structure. This permits these devices to be upgraded to support current and future software image upgrades. Thus, the smaller non-volatile memory sizes in these deployed devices that normally could not support storing two full-functionality copies using the dual bank scheme of the prior art, are able to hold single copies of the larger current full-functionality software image upgrades. To accomplish this, the mechanism utilizes dedicated software incorporated in the degenerated software image and performs the conversion upon installation.

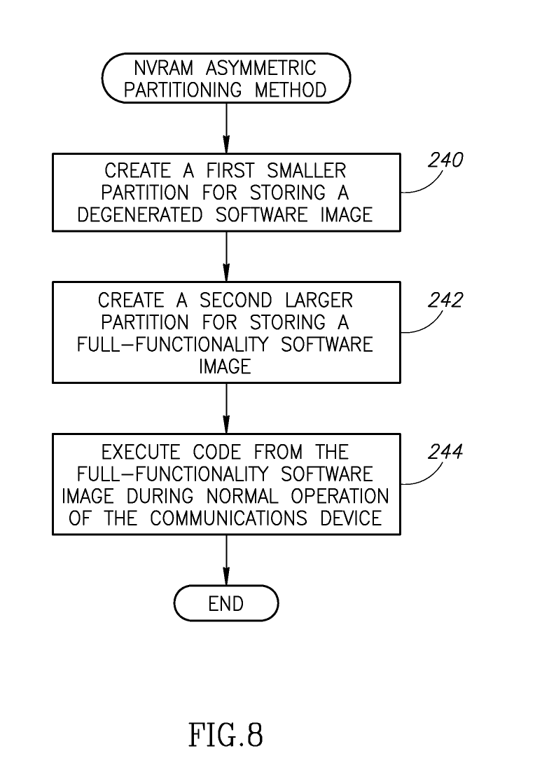

A flow diagram illustrating the non-volatile memory partitioning method of the present invention is shown in FIG. 8. This method can be used for partition new devices as opposed to deployed already installed in the field. First, a smaller partition for storing the degenerated software image is created (step 240). A second and larger partition for storing a full-functionality software image is then created (step 242). Once the partitions in the non-volatile memory are created and the software images stored, the device begins executing code from the full-functionality software image during normal operation of the communications device (step 244).

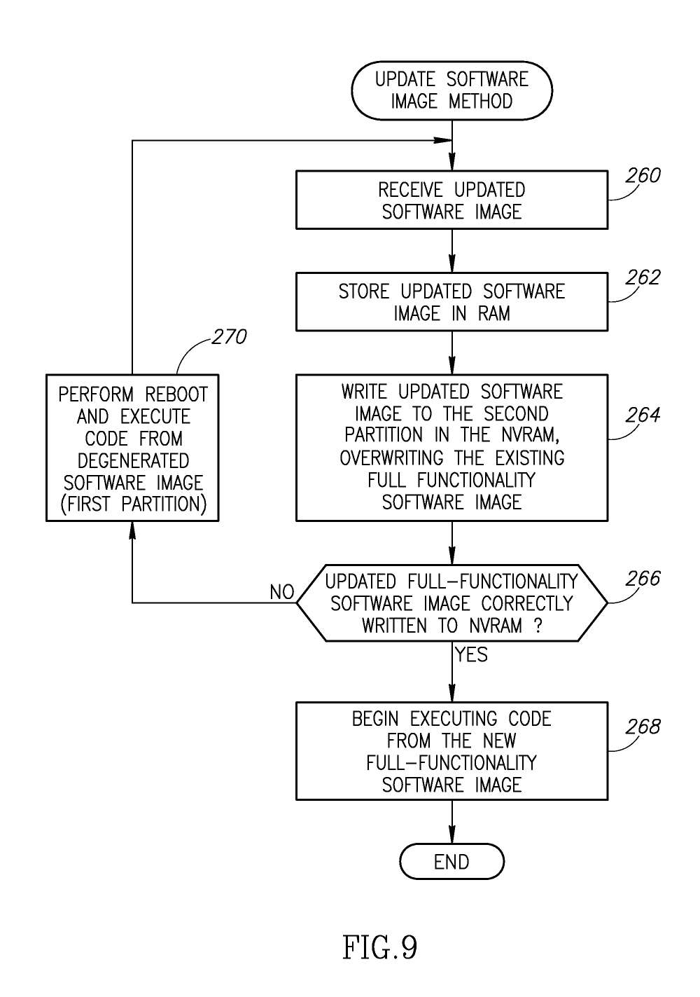

A flow diagram illustrating the update software image method of the present invention is shown in FIG. 9. This method is performed when the software in a communication device having asymmetrical memory partitioning is to be remotely upgraded. First, the updated software image is received from a software image server over the network (step 260). Note that the software image to be upgraded is typically the full-functionality version of the software but may be the degenerated version software, or both. For illustration purposes only, it is assumed that the software image to be upgraded is the full-functionality software image. It is appreciated that a similar procedure applies for upgrading the degenerated software image.

The updated software image is temporarily stored in RAM (step 262). The updated software image is written to the non-volatile memory so as to overwrite the existing full-functionality software image (step 264). It is then checked whether the full-functionality software image was correctly written to the non-volatile memory, such as by verifying CRC codes, etc. (step 266). If the write was successful, the device begins executing code from the new full-functionality software image (step 268). If the write was not successful, the device performs a reboot and executes code from the degenerated software image (i.e. the first partition) and repeats the upgrade process (step 270). This process is repeated until the full-functionality software image is successfully written to the second partition in the non-volatile memory.

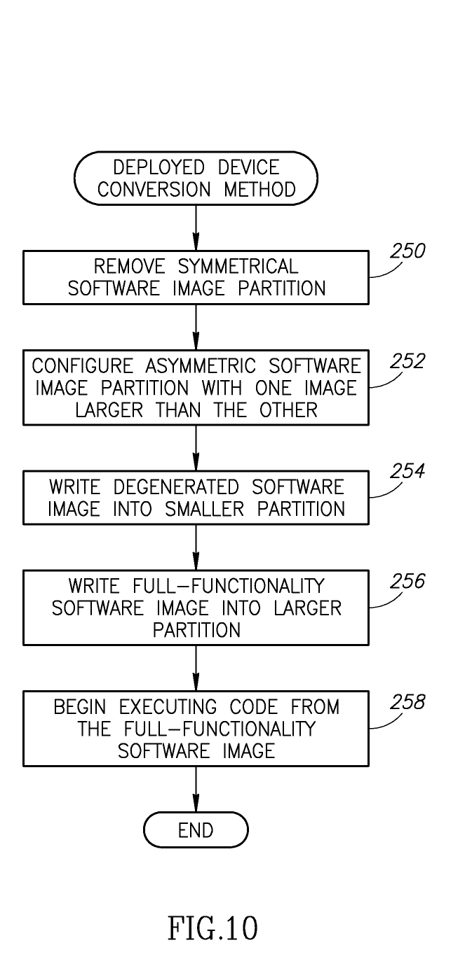

A flow diagram illustrating the deployed device conversion method of the present invention is shown in FIG. 10. This method is intended for use in previously deployed devices where it is desired to convert the legacy symmetric memory structure to an asymmetric memory structure, thereby permitting software upgrades that otherwise would not be possible. First, after receiving both the degenerated and full-functionality software image and storing them in RAM, the device deletes the legacy symmetrical software image partitions (step 250). The asymmetric software image partition is created wherein one partition is larger than the other (step 252). The degenerated software image is written to the smaller partition (step 254) while the full-functionality software image is written to the larger partition (step 256). The device begins executing code from the new full-functionality software image (step 258).

Thus, the asymmetric memory partitioning mechanism provides several benefits including the ability to reduce at least maintain the current cost of devices Bill or Material (BOM) while extending the functionality of the device by enabling the use of smaller non-volatile memory components. Another benefit is that the mechanism provides the ability to perform upgrades of field deployed devices with software images and applications that support additional functionality, which otherwise could not have been used due to non-volatile memory size limitations of the deployed devices. In addition, the mechanism permits upgrades to be performed using a seamless remote process that does not require technician intervention or product replacement.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of partitioning non-volatile memory in a network connected communications device, said method comprising the steps of:
storing a degenerated software image in a first partition of said non-volatile memory; and
storing a single copy of a full-functionality software image in a second partition of said non-volatile memory, said second partition asymmetrical to and larger in size than said first partition.

2. The method according to claim 1, wherein said degenerated software image comprises code for downloading said full-functionality software image from a server over said network.

3. The method according to claim 1, wherein said degenerated software image comprises code for installing said full-functionality software image in said non-volatile memory.

4. The method according to claim 1, wherein said degenerated software image comprises code for enabling said communications device to repeat an upgrade process until said full-functionality software image is successfully installed in said second partition.

5. The method according to claim 1, wherein an updated version of said full-functionality software image is written to said non-volatile memory such that the contents of said second partition are overwritten by said updated version of said full-functionality software image.

6. The method according to claim 1, wherein said full-functionality software image comprises non-essential program code.

7. The method according to claim 1, further comprising the step of booting said communications device from said degenerated software image stored in said first partition in the event said full-functionality software image is not written to said second partition successfully.

8. A method of partitioning non-volatile memory in a network connected communications device, said method comprising the steps of:
receiving an updated full-functionality software image, a single copy of which is to be installed in said non-volatile memory, wherein said non-volatile memory having a first partition for storing a degenerated software image therein and a second partition for storing a full-functionality software image, said second partition asymmetrical to and larger in size than said first partition; and
overwriting the current contents of said second partition with said updated version of said full-functionality software image.

9. The method according to claim 8, further comprising the step of booting said communications device from said degenerated software image stored in said first partition in the event said updated full-functionality software image is not written to said second partition successfully.

10. The method according to claim 8, wherein said degenerated software image comprises code for downloading said full-functionality software image from a server over said network.

11. The method according to claim 8, wherein said degenerated software image comprises code for installing said full-functionality software image in said non-volatile memory.

12. The method according to claim 8, wherein said full-functionality software image comprises non-essential program code.

13. A method of converting non-volatile memory in a previously deployed network connected communications device, said method comprising the steps of:
creating a first partition in said non-volatile memory;
creating a second partition in said non-volatile memory, wherein said second partition is asymmetrical to and larger in size than said first partition;
storing a degenerated software image in said first partition; and
storing a single copy of a full-functionality software image in said second partition of said non-volatile memory.

14. The method according to claim 13, wherein said degenerated software image comprises code for enabling said communications device to repeat an upgrade process until said full-functionality software image is successfully installed in said second partition.

15. The method according to claim 13, wherein an updated version of said full-functionality software image is written to said non-volatile memory such that the contents of said second partition are overwritten by said updated version of said full-functionality software image.

16. The method according to claim 13, wherein said full-functionality software image comprises non-essential program code.

17. A non-volatile memory for use in a network connected communications device, comprising:
a first partition for storing a degenerated software image; and
a second partition for storing a single copy of a full-functionality software image, wherein said second partition is asymmetrical to and larger in size than said first partition.

18. The memory according to claim 17, wherein said degenerated software image comprises code for enabling said communications device to repeat an upgrade process until an updated version of said full-functionality software image is successfully installed in said second partition.

19. The memory according to claim 17, wherein an updated version of said full-functionality software image is written to said non-volatile memory such that the contents of said second partition are overwritten by said updated version of said full-functionality software image.

20. The memory according to claim 17, wherein said full-functionality software image comprises non-essential program code.

21. A cable modem, comprising:
one or more memory modules comprising a non-volatile memory, said non-volatile memory comprising;
a first partition for storing a degenerated software image;
a second partition for storing a single copy of a full-functionality software image, wherein said second partition is asymmetrical to and larger in size than said first partition;
one or more interface ports;
a downstream system connected to a CATV radio frequency (RF) signal input and operative to output a plurality of channel data therefrom;
an upstream system connected to said CATV radio frequency (RF) signal input; and
a processor coupled to said one or more memory modules, said one or more interface ports, said downstream system and said upstream system, said processor operative to implement a media access control (MAC) layer operative to generate a plurality of output channels.

22. The cable modem according to claim 21, wherein said plurality of output channels comprises Data Over Cable Service Interface Specification (DOCSIS) channels.

23. The cable modem according to claim 21, wherein said degenerated software image comprises code for enabling said communications device to repeat an upgrade process until an updated version of said full-functionality software image is successfully installed in said second partition.

24. The cable modem according to claim 21, wherein an updated version of said full-functionality software image is written to said non-volatile memory such that the contents of said second partition are overwritten by said updated version of said full-functionality software image.

25. The cable modem according to claim 21, wherein said full-functionality software image comprises non-essential program code.
